(19) United States
(12) Patent Application Publication
(10) Pub. No.: US 2026/0329788 A1
(43) Pub. Date: Oct. 22, 2026

(54) METHOD FOR COMMUNICATING A DATA BLOCK USING A DATA PIPELINE FOR PROGRAMMABLE LOGIC CONTROLLERS

(71) Applicant: GM Global Technology Operations LLC, Detroit, MI (US)

(72) Inventor: James Allen Ziemke, Sterling Heights, MI (US)

(21) Appl. No.: 19/180,879

(22) Filed: Apr. 16, 2025

(51) Int. Cl. G06F 13/36

(52) U.S. Cl. CPC G06F 13/36; G06F 2213/0064

(57) ABSTRACT

A method for communicating a plurality of data information using a data pipeline from a first programmable logic controller to a second programmable logic controller. The method includes generating a pipeline output header within the first programmable logic controller, determining whether a data block within a plurality of data information has been modified, communicating the plurality of data information across the data pipeline, determining that the plurality of data information was successfully received by the second programmable logic controller using a header, and storing the data within the plurality of data information within the memory of the second programmable logic controller. The data pipeline comprises a plurality of data that carry the plurality of data information from the first programmable logic controller to the second programmable logic controller and vice versa which both have a maximum available pipeline space of 8000 bytes and may have up to 20 segments each.

### INTRODUCTION

The present disclosure relates to a dynamically configurable bi-directional multi-segment data pipeline for programmable logic controllers.

Data pipelines comprise a series of processes in order to communicate and modify data from one programmable logic controller to another. However, current data pipelines rely on fixed data structures for producer-consumer data connections, which limit flexibility by requiring software changes to add or remove data, as well as have a 500-byte bandwidth limitation due to the data pipelines'use of ethernet industrial protocol. These limitations bottleneck the amount of data that can be communicated and modified across the data pipelines over a period of time, meaning that data loads of a greater size to be communicated across the data pipelines may take a significant amount of time to complete.

Thus, while current data pipelines achieve their intended purpose, there is a need for a new and improved system and method for communicating data across data pipelines without the fixed data structure and 500-byte bandwidth limitations.

### SUMMARY

According to several aspects, a method for communicating a plurality of data information between a first programmable logic controller having a memory tag and a second programmable logic controller across a data pipeline is provided. The method may include establishing the data pipeline having a pipeline input array, a pipeline output array, a plurality of data segments, and a pipeline size, wherein the pipeline input array has a pipeline input header and the pipeline output array has a pipeline output header. The method may further include generating the plurality of data information having a block header and a data block. The method may further include loading the block header into the pipeline output header of the pipeline output array. The method may further include comparing the data block of the plurality of data information to a stored data block stored in the memory tag. The method may further include determining that the data block and the stored data block are different based on the comparison of the data block and the stored data block. The method may further include determining that a size of the data block is less than an available pipeline space of the pipeline output array of the data pipeline. The method may further include loading the data block into the pipeline output array when the data block is different than the stored data block and the size of the data block is less than the available pipeline space of the data pipeline. The method may further include copying the data block to the memory tag. The method may further include communicating the block header from the pipeline output header of the pipeline output array to the pipeline input header of the pipeline input array across the data pipeline via the plurality of data segments and data block from the pipeline output array to the pipeline input array across the data pipeline via the plurality of data segments.

In an additional aspect of the present disclosure, the method may further include communicating the plurality of data information between the first programmable logic controller having a memory tag operable within an automatic guided vehicle and the second programmable logic controller operable within an automatic workstation across the data pipeline.

In another aspect of the present disclosure, the method may further include generating the block header comprising a record ID that allows the data pipeline to track the data block.

In an additional aspect of the present disclosure, the method may further include refreshing the pipeline output header when the record ID of the block header cannot be found by the first programmable logic controller.

In another aspect of the present disclosure, the method may further include removing a plurality of loaded headers from the pipeline output header and loading the block header to the pipeline output header.

In an additional aspect of the present disclosure, the method may further include determining that the data block and the stored data block are similar based on the comparison of the data block and the stored data block and communicating the data block in the pipeline output array either continuously or based on a change of state of the data block from the pipeline output array across the data pipeline via the plurality of data segments to the pipeline input array.

In another aspect of the present disclosure, the method may further include determining the available pipeline space to be the space of the pipeline output array unoccupied by either the block header or the data block.

In an additional aspect of the present disclosure, the method may further include determining that a maximum available pipeline space is 400 times the number of data segments in the plurality of data segments in bytes and may be as large as 8000 bytes.

In another aspect of the present disclosure, the method may further include setting a recorded queued bit of the block header to true when the size of the data block is greater than the available pipeline space, preventing the loading of the data block into the pipeline output array.

In an additional aspect of the present disclosure, the method may further include setting the recorded queued bit of the block header to false when the size of the data block is less than or equal to the available pipeline space, allowing for the loading of the data block into the pipeline output array.

In another aspect of the present disclosure, the method may further include copying the data block to the memory tag when the data block is configured to be communicated across the data pipeline based on a change of state of the data block.

In an additional aspect of the present disclosure, the method may further include communicating the block header and the data block via the plurality of data segments having as many as 20 data segments.

According to several aspects, a method for storing a block header and a data block communicated by a first programmable logic controller across a data pipeline into a second programmable logic controller having a plurality of destination tags is provided. The method may include establishing the data pipeline having a pipeline input array, a pipeline output array, a plurality of data segments, wherein the pipeline input array has a pipeline input header and the pipeline output array has a pipeline output header. The method may further include receiving the block header from the pipeline output header of the pipeline output array into the pipeline input header of the pipeline input array and the data block from the pipeline output array into the pipeline input array across the data pipeline via the plurality of data segments. The method may further include determining that the block header and the data block have been successfully received by the pipeline input array. The method may further include storing the data block to one of the plurality of destination tags.

In an additional aspect of the present disclosure, the method may further include determining that the block header and the data block has been synchronized within the plurality of data segments by determining that a transaction ID of each of the plurality of data segments are similar to one another.

In another aspect of the present disclosure, the method may further include locating a record ID of the block header in the pipeline input header.

In an additional aspect of the present disclosure, the method may further include determining that the block header has not been successfully received by the pipeline input array by failing to locate a record ID of the block header in the pipeline input header and zeroing out the data block in the plurality of destination tags.

In another aspect of the present disclosure, the method may further include determining that a space occupied by the data block and the block header within the pipeline input array is similar to a space occupied by a plurality of temporary data within a temporary data array of the second programmable logic controller.

In an additional aspect of the present disclosure, the method may further include determining that a record locator or a record length of the data block does not have a value of zero.

According to several aspects, a method for communicating a plurality of data information having a block header and a data block between a first programmable logic controller having a memory tag and a second programmable logic controller having a plurality of destination tags across a data pipeline and storing the block header and the data block into the plurality of destination tags is provided. The method may include establishing the data pipeline having a pipeline input array, a pipeline output array, a plurality of data segments having up to 20 data segments, and a pipeline size, wherein the pipeline input array has a pipeline input header and the pipeline output array has a pipeline output header. The method may further include generating the plurality of data information having the block header and the data block. The method may further include loading the block header into the pipeline output header of the pipeline output array. The method may further include comparing the data block of the plurality of data information to a stored data block stored in the memory tag. The method may further include determining that the data block and the stored data block are different based on the comparison of the data block and the stored data block. The method may further include determining that a size of the data block is less than an available pipeline space of the pipeline output array of the data pipeline. The method may further include loading the data block into the pipeline output array when the data block is different than the stored data block and the size of the data block is less than the available pipeline space of the data pipeline. The method may further include copying the data block to the memory tag. The method may further include communicating the block header from the pipeline output header of the pipeline output array to the pipeline input header of the pipeline input array across the data pipeline via the plurality of data segments and data block from the pipeline output array to the pipeline input array across the data pipeline via the plurality of data segments when the block header and the data block has been synchronized within the plurality of data segments by determining that a transaction ID of each of the plurality of data segments are similar to one another. The method may further include receiving the block header from the pipeline output header of the pipeline output array into the pipeline input header of the pipeline input array and the data block from the pipeline output array into the pipeline input array across the data pipeline via the plurality of data segments. The method may further include determining that the block header and the data block have been successfully received by the pipeline input array locating a record ID of the block header in the pipeline input header, a space occupied by the data block and the block header within the pipeline input array is similar to a space occupied by a plurality of temporary data within a temporary data array of the second programmable logic controller, and determining that a record locator or a record length of the data block does not have a value of zero. The method may further include storing the data block to one of the plurality of destination tags.

In an additional aspect of the present disclosure, the method may further include communicating the plurality of data information having the block header and the data block between the first programmable logic controller having a memory tag operable within an automatic guided vehicle and the second programmable logic controller having the plurality of destination tags operable within an automated workstation across the data pipeline and storing the block header and the data block into the plurality of destination tags.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram of a system comprising a central programmable logic controller establishing a plurality of data pipelines with a plurality of satellite programmable logic controllers according to an exemplary embodiment;

FIG. 2 is a diagram of the central programmable logic controller, one of the plurality of satellite programmable logic controllers, and one of the plurality of data pipelines between the central programmable logic controller and one of the plurality of satellite programmable logic controllers according to an exemplary embodiment;

FIG. 3 is a diagram of the data block that is to be communicated across the data pipeline according to an exemplary embodiment;

FIG. 4 is a diagram of a write command queue for the data pipeline according to an exemplary embodiment;

FIG. 5 is a flowchart of a method for communicating the data block when associated with a write instruction from the central programmable logic controller to one of the plurality of satellite programmable logic controllers across the data pipeline according to an exemplary embodiment; and

FIG. 6 is a flowchart of a method for executing a read instruction on the data block received from the central programmable logic controller via the data pipeline within at least one of the plurality of satellite programmable logic controllers according to an exemplary embodiment.

### DETAILED DESCRIPTION

The following description is merely exemplary in nature and is not intended to limit the present disclosure, application, or uses.

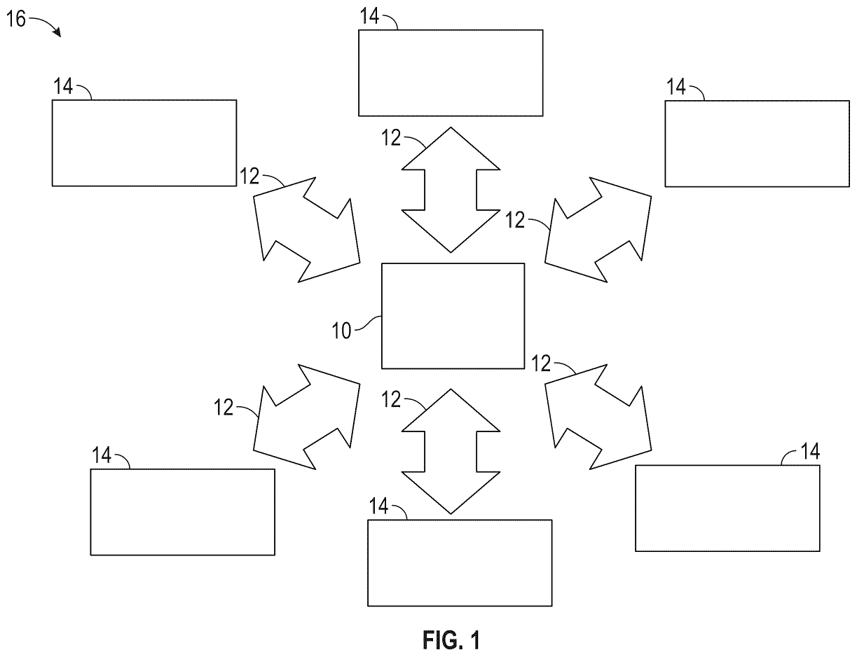

Referring to FIG. 1, a diagram of a system including a central programmable logic controller 10 for establishing a plurality of data pipelines 12 with a plurality of satellite programmable logic controllers 14 is generally indicated by reference number 16. The central programmable logic controller 10 is an industrial digital computer that is configured for the automation and control of a variety of processes, including but not limited to process control, energy management, manufacturing and assembly lines, mining, automotive, food and beverage, and wastewater treatment. The central programmable logic controller 10 oversees the system 16, coordinating and communicating instructions and data flow between the central programmable logic controller 10 and the plurality of satellite programmable logic controllers 14. In a non-limiting list of examples, the central programmable logic controller 10 operable within a server network, personal computer, smartphone, tablet, vehicle, automatic guided vehicle, or automated workstation.

The plurality of satellite programmable logic controllers 14 is least one programmable logic controller that receives instructions and data from the central programmable logic controller 10. Each of the plurality of satellite programmable logic controllers 14 can manage specific aspects of the system 16 and can communicate instructions and data to the central programmable logic controller 10. In a non-limiting list of examples, the central programmable logic controller 10 may be within a server network, personal computer, smartphone, tablet, vehicle, automatic guided vehicle, or automated workstation.

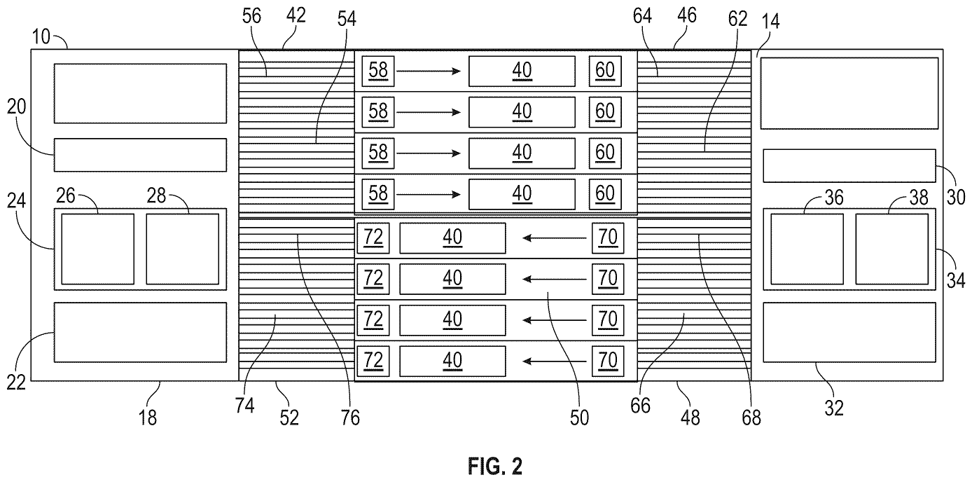

Referring to FIG. 2, a diagram of the central programmable logic controller 10, one of the plurality of satellite programmable logic controllers 14, and a data pipeline 18 which is one of the plurality of data pipelines 12 between the central programmable logic controller 10 and one of the plurality of satellite programmable logic controllers is shown. The central programmable logic controller 10 comprises a central processor 20, a plurality of central instructions 22, and a central memory 24.

The central processor 20 may be a custom made or commercially available processor, a central processing unit (CPU), a graphics processing unit (GPU), an auxiliary processor among several processors associated with the central programmable logic controller 10, a semiconductor-based microprocessor (in the form of a microchip or chip set), or generally a device for executing instructions.

For example, the central processor 20 may operate using Rockwell 5000 series software to facilitate the automation and control of the variety of processes. The Rockwell 5000 series software enables the central programmable logic controller 10 to provide for the organization of control logic into programs and routines and the creation of custom Add-On Instructions (AOIs). The Rockwell 5000 series software further provides for the support of the communication protocol EtherNet/IP for the exchange of data between the central programmable logic controller 10 and other devices such as the plurality of satellite programmable logic controllers 14, and the monitoring of diagnostical data for troubleshooting and optimization purposes. It should be appreciated that the central processor's 20 use of Rockwell 5000 series software is exemplary and in a non-limiting list of examples, the central processor 20 may also use other software with similar features and applications, such as Siemens TIA Portal, Schneider Electric EcoStruxure Control Expert, Mitsubishi GX Works, Omron CX-One, Beckhoff TwinCAT, and AutomationDirect Productivity Suite, and that the use of AOIs in the Rockwell 5000 series software is similar to Function Blocks in the aforementioned software with similar features and applications.

The plurality of central instructions 22 are commands that may be added or removed from the data pipeline 18 that dictates how a plurality of data information 40 within each of the plurality of central instructions 22 should be processed, moved, or transformed. In an exemplary embodiment where the central programmable logic controller 10 and the plurality of satellite programmable logic controllers 14 use Rockwell 5000 series software, the plurality of central instructions 22 allow for the use of custom AOIs that utilize common logic which can increase versatility and efficiency in the use of the plurality of central instructions 22. In a non-limiting list of examples, the plurality of central instructions 22 may have read instructions, write instructions, compare instructions, diagnostics instructions which comprise a header decode instruction and a data monitor instruction, and pipeline management instructions. It should be appreciated that a write instruction from the plurality of central instructions 22 will be received by each of the plurality of satellite programmable logic controllers 14 as a read instruction (referred to as a read/write pair).

The central memory 24 is used to store data such as control logic, software applications, instructions, computer code, data, lookup tables, etc. The central memory 24 includes any type of medium capable of being accessed by a computer, such as read only memory (ROM), random access memory (RAM), a hard disk drive, a compact disc (CD), a digital video disc (DVD), or any other type of memory. The central memory 24 comprises a central memory tag 26 and a plurality of central destination tags 28.

The central memory tag 26 is a location in memory which temporarily holds data when a write instruction is executed. The plurality of central destination tags 28 are locations in memory which permanently store data after a read instruction is successfully executed.

Each of the plurality of satellite programmable logic controllers 14 comprise a satellite processor 30, a plurality of satellite instructions 32, and the satellite memory 34. The satellite processor 30 may be a custom made or commercially available processor, a central processing unit (CPU), a graphics processing unit (GPU), an auxiliary processor among several processors associated with one of the plurality of satellite programmable logic controllers 14, a semiconductor-based microprocessor (in the form of a microchip or chip set), or generally a device for executing instructions. Each satellite processor 30 may operate Rockwell 5000 series software, which carries the same capabilities and functionality as was described with respect to the central processor 20, including the creation of the plurality of satellite instructions 32. Each satellite processor 30 may also use the non-limiting list of other software with similar features and applications to the Rockwell 5000 series software as was described with respect to the central processor 20.

The plurality of satellite instructions 32 are commands that may be added or removed from the data pipeline 18 that dictates how a plurality of data information 40 within each of the plurality of satellite instructions 32 should be processed, moved, or transformed. In an exemplary embodiment where the central programmable logic controller 10 and the plurality of satellite programmable logic controllers 14 use Rockwell 5000 series software, the plurality of satellite instructions 32 allow for the use of custom AOIs that utilize common logic which can increase versatility and efficiency in the use of the plurality of satellite instructions 32. In a non-limiting list of examples, the plurality of satellite instructions 32 may have read instructions, write instructions, compare instructions, diagnostics instructions which comprise a header decode instruction and a data monitor instruction, and pipeline management instructions. It should be appreciated that a write instruction that originates from the plurality of satellite instructions 32 will be received by the central programmable logic controller 10 as a read instruction (referred to as a read/write pair).

The satellite memory 34 has similar form and function to the central memory 24 with the exception that the satellite memory 34 is within each of the plurality of satellite programmable logic controllers 14. The satellite memory 34 further has a satellite memory tag 36 and a plurality of satellite destination tags 38, which have similar form and function to the central memory tag 26 and the plurality of central destination tags 28 respectively.

Referring to FIG. 1 and FIG. 2, the data pipeline 18 from the plurality of data pipelines 12 is a means by which data is communicated between the central programmable logic controller 10 and the plurality of satellite programmable logic controllers 14. In a non-limiting list of examples, the data pipeline 18 may be a physical data pipeline, such as a data pipeline built using physical servers and storage systems or a data pipeline existing over a local network, or an internet-based data pipeline, such as a data pipeline created using cloud services such as Google Cloud, AWS, Azure, etc. It should be appreciated that the data pipeline 18 may be a hybrid data pipeline created using elements from both physical and internet-based data pipelines.

Returning to FIG. 2, the data pipeline 18 includes at least one plurality of data information 40, a central pipeline output array 42, a plurality of central data segments 44, a satellite pipeline input array 46, a satellite pipeline output array 48, a plurality of satellite data segments 50, and a central pipeline input array 52.

The plurality of data information 40 has information that is to be communicated across the data pipeline 18 from the central programmable logic controller 10 to each of the plurality of satellite programmable logic controllers 14 and vice versa. It should be appreciated that more than one plurality of data information 40 can be communicated across the data pipeline 18 simultaneously.

The central pipeline output array 42 is a data structure within the central programmable logic controller 10 used to hold the plurality of data information 40 before the information is communicated from the central programmable logic controller 10 to one of the plurality of satellite programmable logic controllers 14 across the data pipeline 18. The plurality of data information 40 is held within a plurality of central output indices 54 within the central pipeline output array 42 where each of the plurality of central output indices 54 holds a double integer (DINT) that can hold data from a variety of different data types, including but not limited to integers (ints), floats, doubles, characters (chars), strings, bools, and user defined types (UDTs). The first index within the plurality of central output indices 54 indicates the cumulative size of all the data blocks currently within the central pipeline output array 42. The following indices within the plurality of central output indices 54 comprise a central pipeline output header 56 which sequentially indicates the headers of all write instructions of the plurality of central instructions 22 within the central pipeline output array 42, which are described in further detail below. It should be appreciated that the number of indices that make up the central pipeline output header 56 changes based on the number of write instructions in the plurality of central instructions 22 and is therefore does not contain a fixed number of indices. Data of each individual plurality of data information 40 to be loaded sequentially occupies the indices of plurality the central output indices 54 following the central pipeline output header 56 in the order the data blocks were added to the central pipeline output array 42, which is described in further detail below.

The plurality of central data segments 44 is at least one conduit within the data pipeline 18 in which the plurality of data information 40 is communicated across from the central programmable logic controller 10 to at least one of the plurality of satellite programmable logic controllers 14. The plurality of data information 40 communicated across each individual central data segment aligns with the respective index of the central pipeline output array 42 in which the plurality of data information 40 was held. It should be appreciated that there may be as many as 20 central data segments within the plurality of central data segments 44. It should also be appreciated that in an exemplary embodiment where the central programmable logic controller 10 and the plurality of satellite programmable logic controllers use Rockwell 5000 series software, the plurality of central data segments 44 are producer/consumer pipeline segments, allowing the plurality of central data segments 44 to generate and make data available for one of the plurality of satellite programmable logic controllers 14 as a producer segment and to consume data received by the plurality of satellite programmable logic controllers 14 as a consumer segment. It should also be appreciated that when the central programmable logic controller 10 is to make data available for more than one of the plurality of satellite programmable logic controllers 14, distinct data pipelines are utilized for the communication between the central programmable logic controller 10 and each respective satellite programmable logic controller, with each distinct data pipeline having a respective plurality of central data segments.

Each of the plurality of central data segments 44 has a central producer transaction ID 58 within the producer segment of each of the plurality of central data segments 44 and a central consumer transaction ID 60 within the consumer segment of each of the plurality of central data segments 44. The central producer transaction ID 58 and the central consumer transaction ID 60 are integers that track the number of scans of the data pipeline 18 that have taken place when the plurality of data information 40 is communicated from the central programmable logic controller 10 to one of the plurality of satellite programmable logic controllers 14, which is described in further detail below. The central producer transaction ID 58 and the central consumer transaction ID 60 are initialized to a value of “one” and can be incremented to a value of “one hundred”. When the value of the central producer transaction ID 58 is incremented to “one hundred”, the value is reset to a value of “one”. When the value of the central consumer transaction ID 60 is incremented to “one hundred”, the value is reset to a value of “one”.

The satellite pipeline input array 46 is a data structure within each of the plurality of satellite programmable logic controllers 14 used to receive and hold the plurality of data information 40 after the plurality of data information 40 is communicated from the central programmable logic controller 10 to at least one of the plurality of satellite programmable logic controllers 14 across the data pipeline 18. The plurality of data information 40 is held within a plurality of satellite input indices 62 within the satellite pipeline input array 46 and can hold a variety of different data types. The first index within the plurality of satellite input indices 62 indicates the cumulative size of all the data blocks currently within the satellite pipeline input array 46. The following indices of the plurality of satellite input indices 62 comprise a satellite pipeline input header 64 which sequentially indicates the headers of all read instructions of the plurality of satellite instructions 32 within the satellite pipeline input array 46, which are described in further detail below. It should be appreciated that the number of indices that make up the satellite pipeline input header 64 changes based on the number of read instructions in the plurality of satellite instructions 32 and is therefore does not contain a fixed number of indices. Data of each individual plurality of data information 40 to be received sequentially occupies the indices in the plurality of satellite input indices 62 following the satellite pipeline input header 64 in the order the data blocks were added to the satellite pipeline input array 46, which is described in further detail below.

The satellite pipeline output array 48 is a data structure within each of the plurality of satellite programmable logic controllers 14 used to hold the plurality of data information 40 before the plurality of data information 40 is communicated from one of the plurality of satellite programmable logic controllers 14 to the central programmable logic controller 10 across the data pipeline 18. The plurality of data information 40 is held within a plurality of satellite output indices 66 within the satellite pipeline output array 48 where each of the plurality of central output indices 54 holds a double integer (DINT) that can hold data from a variety of different data types, including but not limited to integers (ints), floats, doubles, characters (chars), strings, bools, and user defined types (UDTs). The first index within the plurality of satellite output indices 66 indicates the cumulative size of all the data blocks currently within the satellite pipeline output array 48. The following indices of the plurality of satellite output indices 66 comprise a satellite pipeline output header 68, which sequentially indicates the headers of all write instructions of the plurality of satellite instructions 32 within the satellite pipeline output array 48, which are described in further detail below. It should be appreciated that the number of indices that make up the satellite pipeline output header 68 changes based on the number of write instructions in the plurality of satellite instructions 32 and is therefore does not contain a fixed number of indices. Data of each individual plurality of data information 40 to be loaded sequentially occupies the indices in the plurality of satellite output indices 66 following the satellite pipeline output header 68 in the order the data blocks were added to the satellite pipeline output array 48.

The plurality of satellite data segments 50 is at least one conduit within the data pipeline 18 in which the plurality of data information 40 is communicated across from one of the plurality of satellite programmable logic controllers 14 to the central programmable logic controller 10. The plurality of data information 40 communicated across each individual satellite data segment aligns with the respective index of the satellite pipeline output array 48 in which the plurality of data information 40 was held. It should be appreciated that there may be as many as 20 satellite data segments within the plurality of satellite data segments 50. It should also be appreciated that in an exemplary embodiment where the central programmable logic controller 10 and the plurality of satellite programmable logic controllers use Rockwell 5000 series software, the plurality of satellite data segments 50 are producer/consumer pipeline segments, allowing the plurality of satellite data segments 50 to generate and make data available for the central programmable logic controller 10 as a producer segment and to consume data received by the central programmable logic controller 10 as a consumer segment.

Each of the plurality of satellite data segments 50 has a satellite producer transaction ID 70 within the producer segment of each of the plurality of satellite data segments 50 and a satellite consumer transaction ID 72 within the consumer segment of each of the plurality of satellite data segments 50. The satellite producer transaction ID 70 and the satellite consumer transaction ID 72 are integers that track the number of scans of the data pipeline 18 that have taken place when the plurality of data information 40 is communicated from one of the plurality of satellite programmable logic controllers 14 to the central programmable logic controller 10, which is described in further detail below. The satellite producer transaction ID 70 and the satellite consumer transaction ID 72 are initialized to a value of “one” and can be incremented to a value of “one hundred”. When the value of the satellite producer transaction ID 70 is incremented to “one hundred”, the value is reset to a value of “one”. When the value of the satellite consumer transaction ID 72 is incremented to “one hundred”, the value is reset to a value of “one”.

The central pipeline input array 52 is a data structure within the central programmable logic controller 10 used to receive and hold the plurality of data information 40 after the plurality of data information 40 is communicated from one of the plurality of satellite programmable logic controllers 14 to the central programmable logic controller 10 across the data pipeline 18. The plurality of data information 40 is held within a plurality of central input indices 74 within the central pipeline input array 52 and can hold a variety of different data types. The first index within the plurality of central input indices 74 indicates the cumulative size of all the data blocks currently within the central pipeline output array 42. The following indices of the plurality of central input indices 74 comprise a central pipeline input header 76 which sequentially indicates the headers of all write instructions of the plurality of central instructions 22 within the central pipeline output array 42, which are described in further detail below. It should be appreciated that the number of indices that make up the central pipeline input header 76 changes based on the number of read instructions in the plurality of central instructions 22 and is therefore does not contain a fixed number of indices. Data of each individual plurality of data information 40 to be received sequentially occupies the indices in the plurality of central input indices 74 following the central pipeline input header 76 in the order the data blocks were added to the central pipeline output array 42, which is described in further detail below.

It should be appreciated that the size of the plurality of data information 40 that may be loaded into either the central pipeline output array 42 or the satellite pipeline output array 48, communicated through the plurality of central data segments 44 or the plurality of satellite data segments 50, and be received by either the central pipeline input array 52 or the satellite pipeline input array 46 is dependent on the number of the plurality of central data segments 44 or the number of the plurality of satellite data segments 50 being utilized. Each of the plurality of central data segments 44 and each of the plurality of satellite data segments 50 can communicate up to 400 bytes of data. When there are 20 central data segments or 20 satellite data segments being utilized, the plurality of central data segments 44 and the plurality of satellite data segments 50 can communicate up to 8000 bytes of data each. The size of the data that can be communicated via the plurality of central data segments 44 or the plurality of satellite data segments 50 relative to the number of central data segments or the number of satellite data segments being utilized respectively is referred to as the maximum available pipeline space of either the central pipeline output array 42, the satellite pipeline output array 48, the plurality of central data segments 44, the plurality of satellite data segments 50, the central pipeline input array 52, or the satellite pipeline input array 46. It should also be appreciated that the size of the plurality of data information 40 that may be communicated through each individual data segment within either the plurality of central data segments 44 or the plurality of satellite data segments 50 may be as much as 400 bytes (also referred to as the maximum individual available segment space).

Furthermore, it should be appreciated that some or all of the plurality of data information 40 may be communicated across the data pipeline 18 via more than one of either the plurality of central data segments 44 or the plurality of satellite data segments 50 when the size of the plurality of data information 40 is greater than the maximum individual available segment space and is smaller than the maximum available pipeline space. It should also be appreciated that when the size of the plurality of data information 40 is smaller than the maximum individual available segment space of one of either the plurality of central data segments 44 or the plurality of satellite data segments 50 that is communicating the plurality of data information 40, some or all of the information of a different data block may be communicated simultaneously via the same the same one of either the plurality of central data segments 44 or the plurality of satellite data segments 50.

It should be appreciated that the act of communicating the plurality of data information 40 across the data pipeline 18 via either plurality of central data segments 44 or the plurality of satellite data segments 50 is referred to as a scan of the data pipeline 18. A scan of the data pipeline 18 is a function of a pipeline management instruction. The frequency of a scan of the data pipeline 18 is based on the requested packet interval (RPI) of the plurality of central data segments 44 and the plurality of satellite data segments 50, which defines a frequency in which the plurality of data information 40 is communicated across the data pipeline 18.

In a non-limiting exemplary embodiment where the plurality of data information 40 is communicated across the data pipeline 18 from the central programmable logic controller 10 to one of the plurality of satellite programmable logic controllers 14, a scan of the data pipeline 18 is initiated by transmitting the plurality of data information 40 in each producer segment of the plurality of central data segments 44 to each consumer segment of the plurality of central data segments 44, including setting the value of the central consumer transaction ID 60 to the value of the central producer transaction ID 58. When the values of each central consumer transaction ID 60 of each of the plurality of central data segments 44 are similar, the plurality of data information 40 is copied into the satellite pipeline input array 46 and each central consumer transaction ID 60 is copied into each respective satellite producer transaction ID 70. When the values of each central consumer transaction ID 60 of each of the plurality of central data segments 44 are similar, the entirety of the plurality of data information 40 has been successfully received by the consumer segments of the plurality of central data segments 44 (referred to as the synchronization of the plurality of data information 40). The value of each central producer transaction ID 58 is then incremented by a value of one. It should be appreciated that when the value of each central producer transaction ID 58 is “one hundred”, when each central producer transaction ID 58 is incremented, the value of each central producer transaction ID 58 will be reset to a value of “one”.

In a non-limiting exemplary embodiment where the plurality of data information 40 is communicated across the data pipeline 18 from one of the plurality of satellite programmable logic controllers 14 to the central programmable logic controller 10, a scan of the data pipeline 18 is initiated by transmitting the plurality of data information 40 in each producer segment of the plurality of satellite data segments 50 to each consumer segment of the plurality of satellite data segments 50, including setting the value of the satellite consumer transaction ID 72 to the value of the satellite producer transaction ID 70. When the values of each satellite consumer transaction ID 72 of each of the plurality of satellite data segments 50 are similar, the plurality of data information 40 is copied into the central pipeline input array 52 and each satellite consumer transaction ID 72 is copied into each respective central producer transaction ID 58. When the values of each satellite consumer transaction ID 72 of each of the plurality of satellite data segments 50 are similar, the entirety of the plurality of data information 40 has been successfully received by the consumer segments of the plurality of satellite data segments 50 (referred to as the synchronization of the plurality of data information 40). The value of each satellite producer transaction ID 70 is then incremented by a value of one. It should be appreciated that when the value of each satellite producer transaction ID 70 is “one hundred”, when each satellite producer transaction ID 70 is incremented, the value of each satellite producer transaction ID 70 will be reset to a value of “one”.

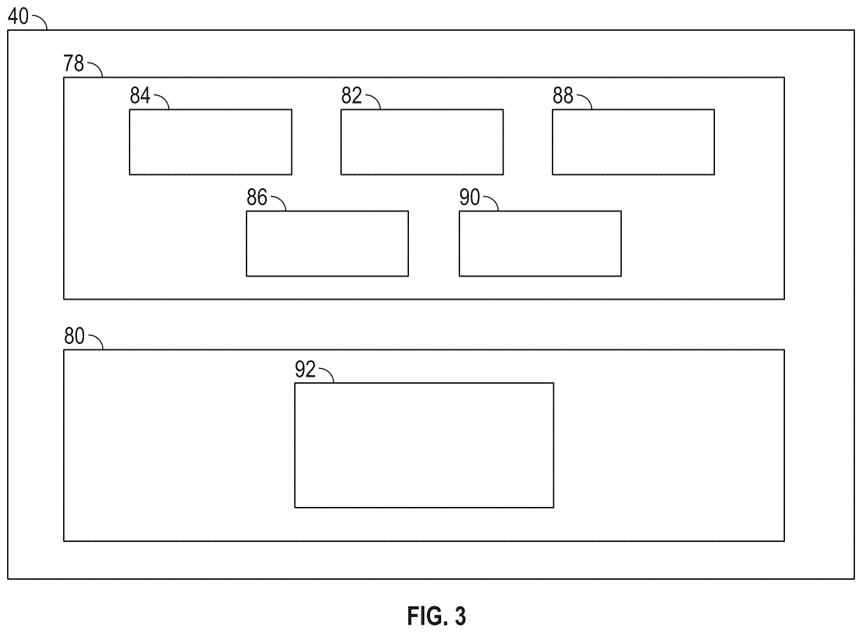

Referring to FIG. 3, a diagram of the plurality of data information 40 within either the plurality of central instructions 22 or the plurality of satellite instructions 32 that is to be communicated across the data pipeline 18 is shown. The plurality of data information 40 comprises a block header 78 and a data block 80.

The block header 78 holds metadata that is pertinent to the respective plurality of data information 40 of the block header 78. The block header 78 is automatically added to or deleted from the central pipeline output array 42 whenever a write instruction is added to or removed from the data pipeline 18 by a pipeline management instruction without an interruption in the communication of data across the data pipeline 18. The block header is loaded into either the central pipeline output header 56 or the satellite pipeline output header 68.

It should be appreciated that when at least one of the plurality of satellite programmable logic controllers 14 is communicating a write instruction across the data pipeline 18 to the central programmable logic controller 10, the block header 78 is automatically generated by each of the satellite pipeline output array 48 of the at least one of the plurality of satellite programmable logic controllers 14. In a non-limiting list of examples, the metadata within the block header 78 may comprise a record ID 82, a record instance 84, a record locator 86, a record queued bit 88, and a record type 90.

The record ID 82 is a unique integer that identifies the plurality of data information 40 between the central programmable logic controller 10 and each of the plurality of satellite programmable logic controllers 14. It should be appreciated that in a non-limiting exemplary embodiment, the record ID 82 has a size of 15 bits when the plurality of data information 40 is processed by a write instruction, a read instruction, or a diagnostics instruction.

The record instance 84 is a four-bit integer that identifies a unique instance of a particular read or write instruction that is associated with a specific record ID. This allows for multiple different data blocks associated with a particular write instruction with an identical record ID to be communicated across the data pipeline 18 provided each of the multiple different data blocks has a different record instance.

The record locator 86 is an integer that identifies where the data block 80 begins within either the central pipeline output array 42, the central pipeline input array 52, the satellite pipeline output array 48, or the satellite pipeline input array 46. It should be appreciated that in an exemplary embodiment where the plurality of data information 40 is associated with a write instruction, read instruction or a diagnostics instruction, the record locator 86 has a size of 11 bits.

The record queued bit 88 is a single bit that indicates whether the plurality of data information 40 is on a write command queue (as is described below) and has not yet been communicated across the data pipeline 18. The record queued bit 88 is set to true by a particular write instruction associated with the block header 78 when the data block 80 is to be added to the write command queue. A read instruction associated with the block header 78 will maintain the information within the data block 80 within either the satellite pipeline input array 46 or the central pipeline input array 52 when the record queued bit 88 is set to true. A read instruction associated with the block header 78 will update the information within the data block 80 when the record queued bit 88 is set to false.

The record type 90 indicates whether the record ID 82 is a task number or a footprint number.

The data block 80 is the data held within the plurality of data information 40 to be communicated across the data pipeline 18 via the plurality of central data segments 44 and the plurality of satellite data segments 50. The data block 80 is loaded into the central pipeline output array 42 after the central pipeline output header 56. The data block 80 includes a record length 92. The record length 92 indicates the size of the data block 80. The record length 92 is loaded into the first of the plurality of central output indices 54 following the central pipeline output header 56. The remaining information of the data block 80 is loaded into the remaining of the plurality of central output indices 54 and occupies as many of the plurality of central output indices 54 as required to hold the entirety of the data block 80. It should be appreciated that in the exemplary embodiment where the plurality of data information 40 is communicated across the data pipeline 18 from one of the plurality of satellite programmable logic controllers 14 to the central programmable logic controller 10, the data block 80 is loaded into the satellite pipeline output array 48 after the satellite pipeline output header 68, the record length 92 is loaded into the first of the plurality of satellite output indices 66 following the satellite pipeline output header 68, and the remaining information of the data block 80 is loaded into the remaining of the plurality of satellite output indices 66.

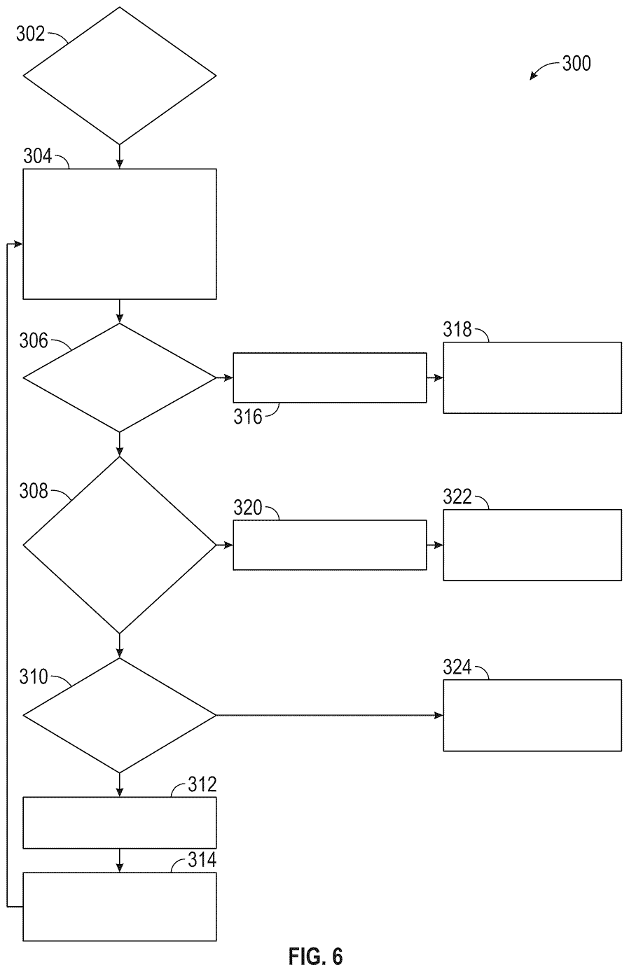

It should be appreciated for each read/write pair, the data structure for the data block 80 within the plurality of data information 40 must be similar between both the read instruction and the write instruction. It should also be appreciated that once a particular write instruction is loaded into the central programmable logic controller 10, the block header 78 associated with that particular write instruction is permanently loaded into either the central pipeline output array 42 or the satellite pipeline output array 48 until the particular write instruction is removed from the logic of either the central programmable logic controller 10 or one of the plurality of satellite programmable logic controllers 14. This allows the particular write instruction's associated read instruction within one of the plurality of satellite programmable logic controllers 14 to find the particular write instruction's block header 78 and be able to determine how to proceed with the data block 80 (as is described in FIG. 6 below).

It should be appreciated that the combination of the record type 90, the record instance 84, and the record ID 82 is referred to as the unique data identifier, which assists the data pipeline 18 in tracking the particular plurality of data information 40 associated with the unique data identifier while the plurality of data information 40 is communicated across the data pipeline 18.

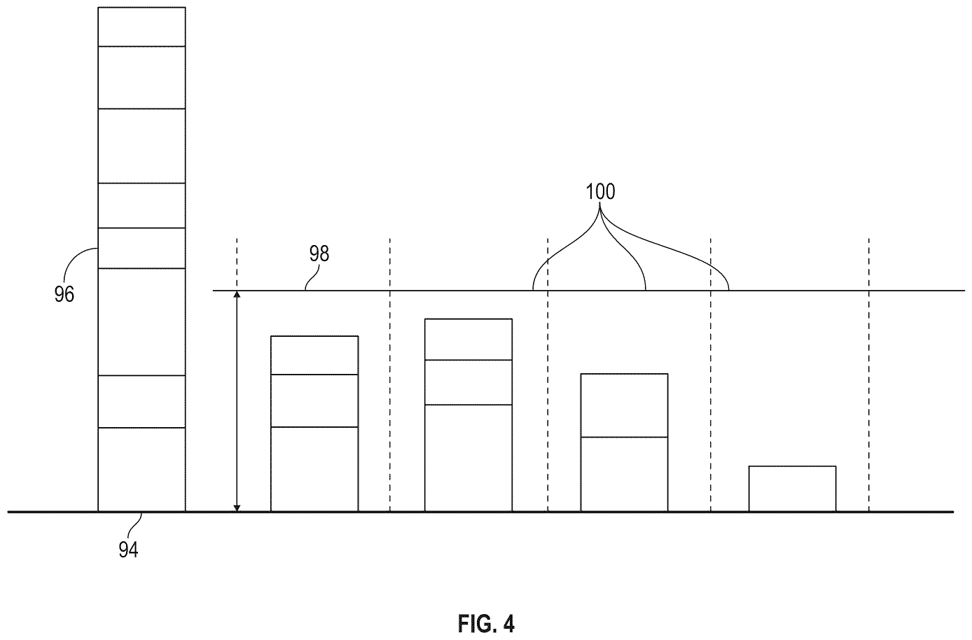

Referring to FIG. 4, a diagram of a write command queue 94 for the data pipeline 18 is shown. The write command queue 94 references a plurality of data blocks that may have a corresponding recorded queued bit set to true when an occupied space of either the central pipeline output array 42 or the satellite pipeline output array 48 exceeds the available pipeline space of and therefore cannot be loaded into either the central pipeline output array 42 or the satellite pipeline output array 48. It should be appreciated that the write command queue 94 is not a location in the central memory 24 or the satellite memory 34. It should also be appreciated that the occupied space of the central pipeline output array 42 is the space in bytes of the central pipeline output array 42 that is taken up by information that is not in the data block 80. It should also be appreciated that the occupied space of the satellite pipeline output array 48 is the space in bytes of the satellite pipeline output array 48 that is taken up by information that is not in the data block 80. It should also be appreciated the available pipeline space of the central pipeline output array 42 is the occupied space of the central pipeline output array 42 subtracted from the maximum available pipeline space of the central pipeline output array 42. It should also be appreciated the available pipeline space of the satellite pipeline output array 48 is the occupied space of the satellite pipeline output array 48 subtracted from the maximum available pipeline space of the satellite pipeline output array 48.

A plurality of write instructions holding a multiple of data blocks 96 determines whether each of the data blocks within the multiple of data blocks 96 may be communicated across the data pipeline 18 by iterating through the multiple of data blocks 96 and adding each data block from the multiple of data blocks 96 sequentially to the central pipeline output array 42. The iteration continues until the next sequential data block's size in bytes causes the occupied space of either the central pipeline output array 42 or the satellite pipeline output array 48 to exceed the available pipeline space of either the central pipeline output array 42 or the satellite pipeline output array 48 in a first scan 98. When the occupied space exceeds the available pipeline space, the write instruction associated with the sequential data block sets the record queued bit 88 of the block header 78 to true. When the sequential data block is determined to fit within central pipeline output array 42, the sequential data block is added to the central pipeline output array 42 and the record queued bit 88 in the block header 78 is set to false. It should be appreciated that the first scan 98 is the first instance of a scan of the data pipeline 18 occurring.

In the exemplary embodiment where the plurality of data information 40 is communicated from the central programmable logic controller 10 to the plurality of satellite programmable logic controllers 14, the size of a loaded data block that can fit into the first scan 98 is compared to occupied space of the central pipeline output array 42. In the exemplary embodiment where the plurality of data information 40 is communicated from the any of the plurality of satellite programmable logic controllers 14 to the central programmable logic controller 10, the size of the loaded data block that can fit into the first scan 98 is compared to the occupied space of the satellite pipeline output array 48. The plurality of write instructions then continues to iterate through the entire multiple of data blocks 96 until each individual data block can either be determined to fit within the first scan 98 or the recorded queued bit in the block header associated with the individual data block is set to true due to the size of the individual data block being too great to fit within the first scan 98.

The write command queue 94 then repeats the iteration, adding individual data blocks from the multiple of data blocks 96 to a plurality of subsequent scans 100 of the data pipeline 18 until the record queued bit 88 of all of the block headers associated with each of the data blocks is set to false.

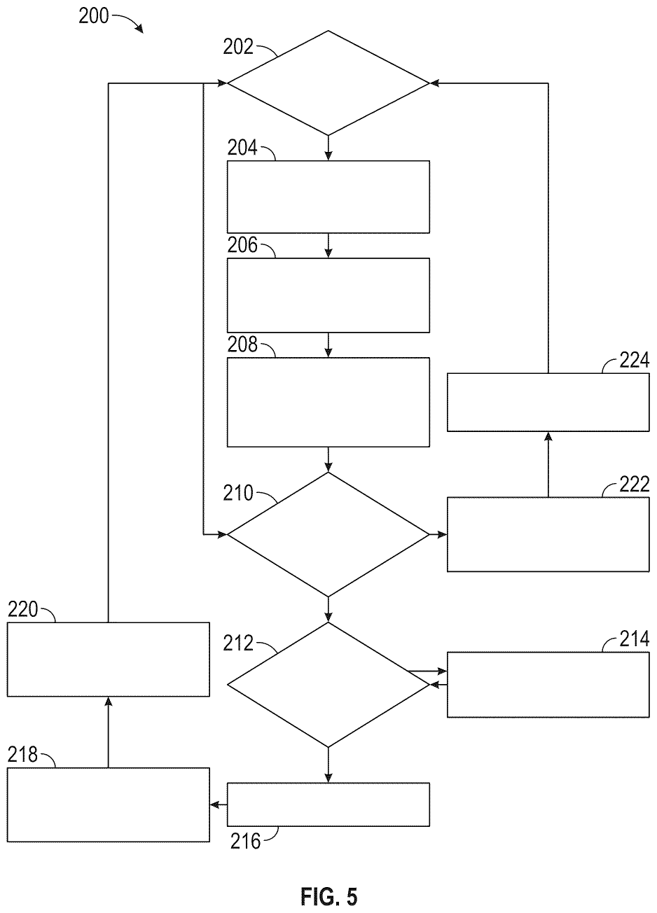

Referring to FIG. 5, a flowchart of a method 200 for communicating the plurality of data information 40 when associated with a write instruction from the central programmable logic controller 10 to one of the plurality of satellite programmable logic controllers 14 across the data pipeline 18 is shown. It should be appreciated that while in this exemplary embodiment, the central programmable logic controller 10 is communicating the plurality of data information 40 to one of the plurality of satellite programmable logic controllers 14, the central programmable logic controller 10 can communicate the information of more than one data block with all of the plurality of satellite programmable logic controllers 14 simultaneously, where the communication between the central programmable logic controller 10 and each of the plurality of satellite programmable logic controllers 14 utilizes a respective data pipeline. It should also be appreciated that each of the plurality of satellite programmable logic controllers 14 can communicate the plurality of data information 40 when associated with a write instruction to the central programmable logic controller 10. It should also be appreciated that while in this exemplary embodiment the central programmable logic controller 10 contains only write instructions and one of the plurality of satellite programmable logic controllers 14 contains only read instructions, both types of programmable logic controllers can contain read instructions and write instructions. The method 200 begins with step 202, where the central processor 20 searches for the record ID 82 of the plurality of data information 40 in the central pipeline output header 56. When the record ID 82 is not found, the method 200 then proceeds to step 204.

At step 204, a header refresh request flag is set to true and a plurality of headers within the central pipeline output header 56 are removed. The header refresh request flag indicates that the unique data identifier within the block header 78 is incomplete and that the block header 78 must be rebuilt. In a non-limiting list of examples, the header refresh request flag may be a Boolean variable that may be set to true or false or may be a bit that may be set to 0 or 1. The method 200 then proceeds to step 206.

At step 206, the header refresh request flag is set to false and a header refresh in-progress flag is set to true. The header refresh in-progress flag indicates that central pipeline output header 56 is in the process of being rebuilt. In a non-limiting list of examples, the header refresh in-progress flag may be a Boolean variable that may be set to true or false or may be a bit that may be set to 0 or 1. The method 200 then proceeds to step 208.

At step 208, each instance of the plurality of data information 40 as indicated by the record instance 84 will load the block header 78 of the plurality of data information 40 to the central pipeline output header 56. It should be appreciated that while the write instruction associated with the plurality of data information 40 adds the block header 78 to the central pipeline output header 56, a pipeline management instruction is executed to oversee the complete central pipeline output header 56 refresh process. The method 200 then proceeds to step 210.

At step 210, the header refresh in-progress flag is set to false and a compare instruction is executed to determine whether the data block 80 currently within the plurality of data information 40 has been modified by determining whether the data block 80 currently within the plurality of data information 40 is similar to the value of a plurality of copied block data stored within the central memory tag 26. When the data block 80 currently within the plurality of data information 40 is not similar to the value of the plurality of copied block data stored within the central memory tag 26, the method 200 then proceeds to step 212.

At step 212, a data refresh flag is set to true and the size of the data block 80 in bytes is compared to the available pipeline space of the central pipeline output array 42.

It should be appreciated that while in this exemplary embodiment, the size of the data block 80 and the size of the loaded data block are compared in bytes, the comparison can be done in smaller data sizes, such as half-bytes, nibbles, and bits. When the size of the data block 80 is greater than the available pipeline space of the central pipeline output array 42, the method 200 then proceeds to step 214.

At step 214, the data block 80 is added to the write command queue 94 by setting the record queued bit 88 to true. The method 200 then proceeds to step 212.

Returning to step 212, when the size of the data block 80 is less than or equal to the available pipeline space of the central pipeline output array 42, the method 200 then proceeds to step 216.

At step 216, the write instruction associated with the plurality of data information 40 loads the data block 80 into the central pipeline output array 42. The data refresh flag indicates that the data block 80 is being loaded into the central pipeline output array 42. In a non-limiting list of examples, the data refresh flag may be a Boolean variable that may be set to true or false or may be a bit that may be set to 0 or 1. It should also be appreciated that when the data block 80 was previously added to the write command queue 94, the record queued bit 88 is set to false. The method 200 then proceeds to step 218.

At step 218, the plurality of data information 40 is communicated across the data pipeline 18 via the plurality of central data segments 44 from the central pipeline output array 42 to the satellite pipeline input array 46 of at least one of the plurality of satellite programmable logic controllers 14. The plurality of data information 40 will be communicated across the data pipeline 18 either continuously or based on a change of state of the data block 80 from at least one of the plurality of satellite programmable logic controllers 14 depending on the configuration of the write instruction associated with the plurality of data information 40. The method 200 then proceeds to step 220.

At step 220, the data block 80 of the plurality of data information 40 is copied into the central memory tag 26. It should be appreciated that step 220 is optional and is only executed when the write instruction associated with the plurality of data information 40 is configured to communicate the data block 80 across the data pipeline 18 based on a change of state of the data block 80. The method 200 then proceeds to step 202.

Returning to step 202, when the record ID 82 of the plurality of data information 40 is found, the method 200 then proceeds to step 210.

Returning to step 210, when the data block 80 currently within the plurality of data information 40 is similar to the value of the plurality of copied block data stored within the central memory tag 26, the method 200 then proceeds to step 222.

At step 222, the plurality of data information 40 will be communicated across the data pipeline 18 either continuously or based on a change of state of the information within the plurality of data information 40 from at least one of the plurality of satellite programmable logic controllers 14 depending on the configuration of the write instruction associated with the plurality of data information 40. The method 200 then proceeds to step 224.

At step 224, the data block 80 of the plurality of data information 40 is copied into the central memory tag 26. It should be appreciated that step 220 is optional and is only executed when the write instruction associated with the plurality of data information 40 is configured to communicate the data block 80 across the data pipeline 18 based on a change of state of the data block 80. The method 200 then proceeds to step 202.

It should be appreciated that in the exemplary embodiment where at least one of the plurality of satellite programmable logic controllers 14 is communicating the plurality of data information 40 when associated with a write instruction, the method 200 would be executed in the same fashion with the components of the programmable logic controllers being switched. This means that central programmable logic controller 10, at least one of the plurality of satellite programmable logic controllers 14, central pipeline output array 42, satellite pipeline input array 46, plurality of central data segments 44, central memory tag 26, central processor 20, and central pipeline output header 56 would be changed to be one of the plurality of satellite programmable logic controllers 14, central programmable logic controller 10, satellite pipeline output array 48, central pipeline input array 52, plurality of satellite data segments 50, satellite memory tag 36, satellite processor 30, and satellite pipeline output header 68 respectively. It should further be appreciated that the header refresh request flag, the header refresh in-progress flag, and the data refresh flag are within a pipeline management instruction.

Referring to FIG. 6, a flowchart of a method 300 for executing a read instruction on the plurality of data information 40 received from the central programmable logic controller 10 via the data pipeline 18 within at least one of the plurality of satellite programmable logic controllers 14 is shown. It should be appreciated that while only the communication between the central programmable logic controller 10 and one of the plurality of satellite programmable logic controllers 14 is demonstrated in this exemplary embodiment, the method 300 can be executed between the central programmable logic controller 10 and up to all of the plurality of satellite programmable logic controllers 14 simultaneously, where the communication between the central programmable logic controller 10 and each of the plurality of satellite programmable logic controllers 14 utilizes a respective data pipeline. It should also be appreciated that while in this exemplary embodiment one of the plurality of satellite programmable logic controllers 14 receives the plurality of data information 40 from the central programmable logic controller 10, in another exemplary embodiment, the central programmable logic controller 10 may receive the plurality of data information 40 from one of the plurality of satellite programmable logic controllers 14. The method 300 begins at step 302, determining that each of the satellite consumer transaction IDs are similar to one another. When each of the satellite consumer transaction IDs are not similar to one another, the method 300 repeats step 302. When each of the satellite consumer transaction IDs are similar to one another, the method 300 then proceeds to step 304.

At step 304, the satellite pipeline input array 46 receives the plurality of data information 40 communicated by the central programmable logic controller in either step 218 or step 222 of the method 200. The method 300 then proceeds to step 306.

At step 306, the satellite processor 30 searches for the record ID 82 within the block header 78 that was communicated to the satellite pipeline input header 64. When the record ID 82 is found, the method 300 then proceeds to step 308.

At step 308, the satellite processor 30 determines whether the space occupied by the data block 80 within the plurality of satellite input indices 62 and the space occupied by the block header 78 within the satellite pipeline input header 64 is similar to a space occupied by data not belonging to the plurality of data information 40 within a temporary data array of one of the plurality of satellite programmable logic controllers 14. When the space occupied by the data block 80 and the block header 78 within the plurality of satellite input indices 62 is similar to the space occupied by data not belonging to the plurality of data information 40 within the temporary data array, the method 300 then proceeds to step 310.

At step 310, the satellite processor 30 determines whether the record locator 86 or the record length 92 of the data block 80 has a value of zero. When neither the record locator 86 or the record length 92 has a value of zero, the method 300 then proceeds to step 312.

At step 312, a data ready flag is set to true by a read instruction associated with the data block 80 created by the satellite processor 30. The data ready flag indicates that the plurality of data information 40 has been successfully communicated across the data pipeline 18 and may be copied into the plurality of satellite destination tags 38. In a non-limiting list of examples, the data ready flag may be a Boolean variable that may be set to true or false or may be a bit that may be set to 0 or 1. The method 300 then proceeds to step 314.

At step 314, the data block 80 is copied into one of the plurality of satellite destination tags 38. The method 300 then proceeds to step 302.

Returning to step 306, when the record ID 82 is not found, the method 300 then proceeds to step 316.

At step 316, a datanok flag is set to true by the satellite processor 30 and the data block 80 in the plurality of satellite destination tags 38 is zeroed out. It should be appreciated that only the data block 80 is zeroed out in the plurality of satellite destination tags 38 and other data blocks besides the data block 80 would be maintained. The datanok flag indicates that there is an error within the data block 80 or that the data block 80 is incomplete. In a non-limiting list of examples, the datanok flag may be a Boolean variable that may be set to true or false or may be a bit that may be set to 0 or 1. The method 300 then proceeds to step 318.

At step 318, the data block 80 is copied into one of the plurality of satellite destination tags 38 using the temporary data array. The method 300 then proceeds to step 302.

Returning to step 308, When the space occupied by the data block 80 and the block header 78 within the plurality of satellite input indices 62 is not similar to the space occupied by data not belonging to the plurality of data information 40 within the temporary data array, the method 300 then proceeds to step 320.

At step 320, the datanok flag is set to true by the satellite processor 30 and the data block 80 in the plurality of satellite destination tags 38 is zeroed out. It should be appreciated that only the data block 80 is zeroed out in the plurality of satellite destination tags 38 and other data blocks besides the data block 80 would be maintained. The method 300 then proceeds to step 322.

At step 322, the data block 80 is copied into one of the plurality of satellite destination tags 38 using the temporary data array. The method 300 then proceeds to step 302.

Returning to step 310, when either the record locator 86 or the record length 92 has a value of zero, the method 300 then proceeds to step 324.

At step 324, the data ready flag is set to false by the satellite processor 30, indicating that the data block 80 will not be copied into the plurality of satellite destination tags 38 and the previous data within the plurality of satellite destination tags 38 will be maintained. The method 300 then continues to step 302.

It should be appreciated that in the exemplary embodiment where at least one of the plurality of satellite programmable logic controllers 14 is communicating the plurality of data information 40 when associated with a write instruction, the method 300 would be executed in the same fashion with the components of the programmable logic controllers being switched. This means that central programmable logic controller 10, at least one of the plurality of satellite programmable logic controllers 14, satellite pipeline input array 46, plurality of central data segments 44, plurality of satellite destination tags 38, satellite processor 30, satellite consumer transaction IDs, and satellite pipeline input header 64 would be changed to be one of the plurality of satellite programmable logic controllers 14, central programmable logic controller 10, central pipeline input array 52, plurality of satellite data segments 50, plurality of central destination tags 28, central processor 20, central consumer transaction IDs, and central pipeline input header 76 respectively. It should further be appreciated that the data ready flag and the datanok flag are within a pipeline management instruction.

The data pipeline 18 of the present disclosure offers several advantages. These include having a maximum of 20 segments in the plurality of central data segments 44 and the plurality of satellite data segments 50, being able to communicate a maximum of 8000 bytes across each of the plurality of central data segments 44 and the plurality of satellite data segments 50, and the ability to dynamically add and remove write instructions and read instructions from the data pipeline 18. Furthermore, the data pipeline 18 of the present disclosure allows for the automatic refresh of the central pipeline output header 56 when write instructions are added or removed from the data pipeline 18 and the implementation of a write command queue 94 that assists in communicating the plurality of data information 40 across the data pipeline 18 when the size of data blocks of the multiple of data blocks 96 to be communicated is greater than the maximum available pipeline space of the central pipeline output array 42 and the maximum available pipeline space of the satellite pipeline output array 48. The data pipeline 18 of the present disclosure ensures that the plurality of data information 40 is synchronized by using transaction IDs to ensure that the plurality of data information 40 is current to each respective scan of the data pipeline 18. Additionally, the system 16 enables flexibility and modularity in the setup of the programmable logic controllers, where in a non-limiting list of examples, the central programmable logic controller 10 communicates the plurality of data information 40 across the data pipeline 18 to only one satellite programmable logic controller, communicates to each of the plurality of satellite programmable logic controllers 14 using a respective data pipeline, or the central programmable logic controller 10 communicates the plurality of data information 40 across the data pipeline 18 to only one satellite programmable logic controller, which then communicates the plurality of data information 40 further across a separate data pipeline to another satellite programmable logic controller.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for communicating a plurality of data information between a first programmable logic controller having a memory tag and a second programmable logic controller across a data pipeline, the method comprising:
establishing the data pipeline having a pipeline input array, a pipeline output array, a plurality of data segments, and a pipeline size, wherein the pipeline input array has a pipeline input header and the pipeline output array has a pipeline output header;
generating the plurality of data information having a block header and a data block;
loading the block header into the pipeline output header of the pipeline output array;
comparing the data block of the plurality of data information to a stored data block stored in the memory tag;
determining that the data block and in the stored data block are different based on the comparison of the data block and the stored data block;
determining that a size of the data block is less than an available pipeline space of the pipeline output array of the data pipeline;
loading the data block into the pipeline output array when the data block is different than the stored data block and the size of the data block is less than the available pipeline space of the data pipeline;
copying the data block to the memory tag; and
communicating the block header from the pipeline output header of the pipeline output array to the pipeline input header of the pipeline input array across the data pipeline via the plurality of data segments and data block from the pipeline output array to the pipeline input array across the data pipeline via the plurality of data segments.

2. The method of claim 1 further comprising communicating the plurality of data information between the first programmable logic controller having a memory tag operable within an automatic guided vehicle and the second programmable logic controller operable within an automatic workstation across the data pipeline.

3. The method of claim 1, wherein generating the plurality of data information further comprises generating the block header comprising a record ID that allows the data pipeline to track the data block.

4. The method of claim 3 further comprising refreshing the pipeline output header when the record ID of the block header cannot be found by the first programmable logic controller.

5. The method of claim 4, wherein refreshing the pipeline output header further comprises removing a plurality of loaded headers from the pipeline output header and loading the block header to the pipeline output header.

6. The method of claim 1 further comprising determining that the data block and the stored data block are similar based on the comparison of the data block and the stored data block and communicating the data block in the pipeline output array either continuously or based on a change of state of the data block from the pipeline output array across the data pipeline via the plurality of data segments to the pipeline input array.

7. The method of claim 1, wherein determining whether a size of the data block is less than an available pipeline space of the pipeline output array of the data pipeline further comprises determining the available pipeline space to be the space of the pipeline output array unoccupied by either the block header or the data block.

8. The method of claim 7, wherein determining whether a size of the data block is less than an available pipeline space of the pipeline output array of the data pipeline further comprises determining that a maximum available pipeline space is 400 times the number of data segments in the plurality of data segments in bytes and may be as large as 8000 bytes.

9. The method of claim 1 further comprising setting a recorded queued bit of the block header to true when the size of the data block is greater than the available pipeline space, preventing the loading of the data block into the pipeline output array.

10. The method of claim 9 further comprising setting the recorded queued bit of the block header to false when the size of the data block is less than or equal to the available pipeline space, allowing for the loading of the data block into the pipeline output array.

11. The method of claim 1, wherein copying the data block to the memory tag further comprises copying the data block to the memory tag when the data block is configured to be communicated across the data pipeline based on a change of state of the data block.

12. The method of claim 1, wherein communicating the block header from the pipeline output header of the pipeline output array to the pipeline input header of the pipeline input array across the data pipeline via the plurality of data segments and the data block from the pipeline output array to the pipeline input array across the data pipeline via the plurality of data segments further comprises communicating the block header and the data block via the plurality of data segments having as many as 20 data segments.

13. A method for storing a block header and a data block communicated by a first programmable logic controller across a data pipeline into a second programmable logic controller having a plurality of destination tags, the method comprising:
establishing the data pipeline having a pipeline input array, a pipeline output array, a plurality of data segments, wherein the pipeline input array has a pipeline input header and the pipeline output array has a pipeline output header;
receiving the block header from the pipeline output header of the pipeline output array into the pipeline input header of the pipeline input array and the data block from the pipeline output array into the pipeline input array across the data pipeline via the plurality of data segments;
determining that the block header and the data block have been successfully received by the pipeline input array; and
storing the data block to one of the plurality of destination tags.

14. The method of claim 13 further comprising determining that the block header and the data block has been synchronized within the plurality of data segments by determining that a transaction ID of each of the plurality of data segments are similar to one another.

15. The method of claim 13, wherein determining that the block header has been successfully received by the pipeline input array further comprises locating a record ID of the block header in the pipeline input header.

16. The method of claim 13 further comprising determining that the block header has not been successfully received by the pipeline input array by failing to locate a record ID of the block header in the pipeline input header and zeroing out the data block in the plurality of destination tags.

17. The method of claim 13, wherein determining that the data block has been successfully received by the pipeline input array further comprises determining that a space occupied by the data block and the block header within the pipeline input array is similar to a space occupied by a plurality of temporary data within a temporary data array of the second programmable logic controller.

18. The method of claim 13, wherein determining that the data block has been successfully received by pipeline input array further comprises determining that a record locator or a record length of the data block does not have a value of zero.

19. A method for communicating a plurality of data information having a block header and a data block between a first programmable logic controller having a memory tag and a second programmable logic controller having a plurality of destination tags across a data pipeline and storing the block header and the data block into the plurality of destination tags, the method comprising:
establishing the data pipeline having a pipeline input array, a pipeline output array, a plurality of data segments having up to 20 data segments, and a pipeline size, wherein the pipeline input array has a pipeline input header and the pipeline output array has a pipeline output header;
generating the plurality of data information having the block header and the data block;
loading the block header into the pipeline output header of the pipeline output array;
comparing the data block of the plurality of data information to a stored data block stored in the memory tag;
determining that the data block and the stored data block are different based on the comparison of the data block and the stored data block;
determining whether a size of the data block is less than an available pipeline space of the pipeline output array of the data pipeline;
loading the data block into the pipeline output array when the data block is different than the stored data block and the size of the data block is less than the available pipeline space of the data pipeline;
copying the data block to the memory tag;
communicating the block header from the pipeline output header of the pipeline output array to the pipeline input header of the pipeline input array across the data pipeline via the plurality of data segments and data block from the pipeline output array to the pipeline input array across the data pipeline via the plurality of data segments when the block header and the data block has been synchronized within the plurality of data segments by determining that a transaction ID of each of the plurality of data segments are similar to one another;
receiving the block header from the pipeline output header of the pipeline output array into the pipeline input header of the pipeline input array and the data block from the pipeline output array into the pipeline input array across the data pipeline via the plurality of data segments;
determining that the block header and the data block have been successfully received by the pipeline input array locating a record ID of the block header in the pipeline input header, a space occupied by the data block and the block header within the pipeline input array is similar to a space occupied by a plurality of temporary data within a temporary data array of the second programmable logic controller, and determining that a record locator or a record length of the data block does not have a value of zero; and
storing the data block to one of the plurality of destination tags.

20. The method of claim 19 further comprising communicating the plurality of data information having the block header and the data block between the first programmable logic controller having a memory tag operable within an automatic guided vehicle and the second programmable logic controller having the plurality of destination tags operable within an automated workstation across the data pipeline and storing the block header and the data block into the plurality of destination tags.
